(19) United States
(12) Patent Application Publication
(10) Pub. No.: US 2007/0172635 A1
(43) Pub. Date: Jul. 26, 2007

(54) Gluing construction

(75) Inventor: Thomas Vogler, Bad Salzuflen (DE)

Correspondence Address: COHEN, PONTANI, LIEBERMAN & PAVANE, 551 FIFTH AVENUE, SUITE 1210, NEW YORK, NY, 10176, US

(73) Assignee: Dorma GmbH + Co. KG, Ennepetal (DE)

(21) Appl. No.: 10/590,600

(22) PCT Filed: Feb. 23, 2005
(86) PCT No.: PCT/EP05/01877

§ 371 Date: Sep. 18, 2006

(30) Foreign Application Priority Data
Feb. 26, 2004 (DE) 10 2004 009 880.8

(51) Int. Cl. E05D 15/06

(52) U.S. Cl. 428/195.1

(57) ABSTRACT

An adhesive system including a structural component to be mounted to a base structure, the structural component having a first bonding location and a second bonding location. The adhesive system also includes a primary bonding applied to the first bonding location of the structural component to bond the structural component to the base structure, the primary bonding comprising an adhesive of a sufficient strength to securely bond the structural component to the base structure; and a secondary bonding applied to the second bonding location of the structural component to bond the structural component to the base structure, the secondary bonding comprising an elastically stretchable adhesive.

The invention relates to an adhesive system according to claim 1, by means of which structural components are connected to each other through bonding.

Such adhesive systems need to have a sufficient redundancy, meaning that a failure of the adhesive system must not result in a failure of the whole system. Many adhesives are characterized by great strength; however, they are very sensitive to the surrounding medium. Known bondings can age and as a result break, i.e. the bonding fails, such that the structural components may become loose and may fall out of the system. If, for example, the structural component is a glass pane, this glass pane could be destroyed when falling out of the adhesive system.

Therefore, it is an object of the present invention to provide an adhesive system of the type indicated in the generic part of patent claim 1, which allows to avoid destruction or damage of the bonded structural components in case of a failure of the bonding.

This object is achieved by the features of patent claim 1.

Compared to known adhesive systems, the invention provides the advantage of having a secondary bonding, which eliminates a failure of the whole system (redundancy). If the primary bonding were to fail during its operating life, the loads would be shifted to the secondary bonding. In this way, the secondary bonding fulfils the required redundancy of the system.

Advantageous further developments of the invention are set forth in the dependent claims.

Hereinafter, embodiments of the invention will be explained based on the drawings, in which:

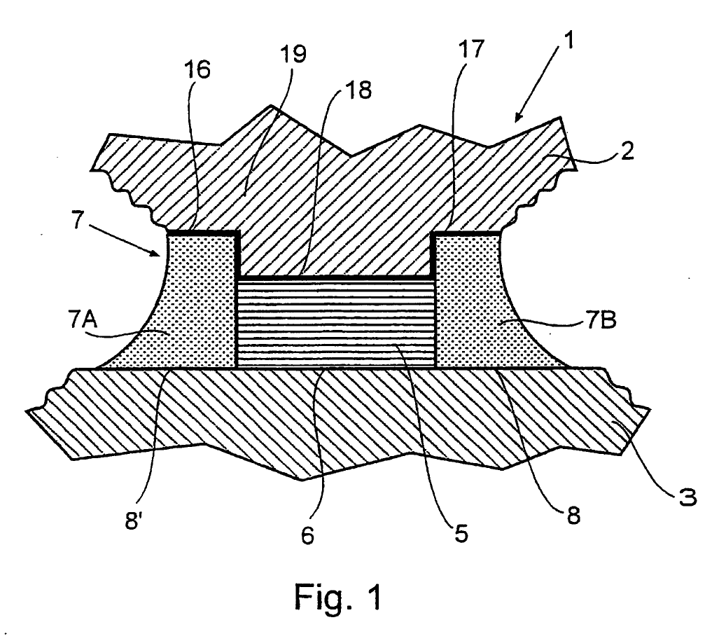

FIG. 1 is a sectional illustration of a first embodiment of an inventive adhesive system;

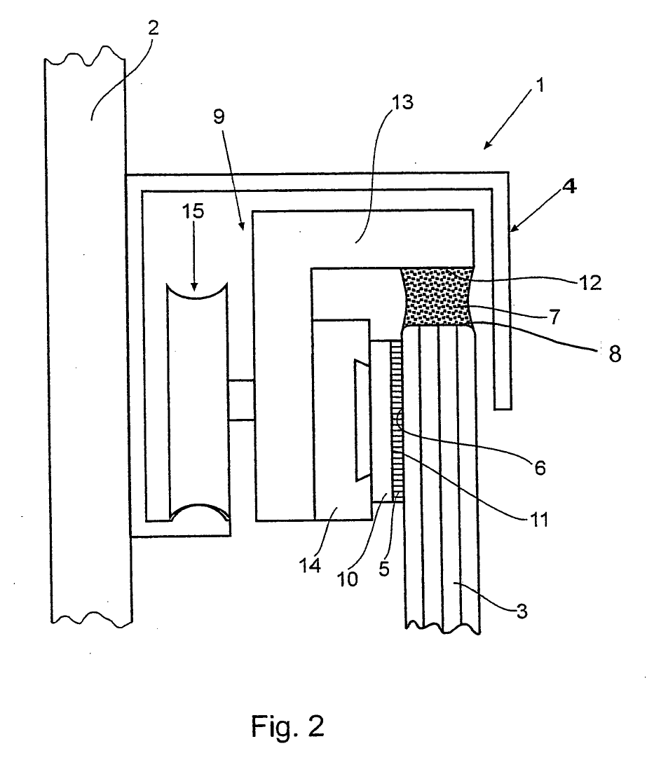

FIG. 2 shows a simplified sectional illustration of a second embodiment of an inventive adhesive system in combination with a sliding door.

According to FIG. 1, an adhesive system 1 is illustrated, which is provided with a primary bonding 5 and a secondary bonding 7. As can be seen in FIG. 1, the secondary bonding 7 has two bonding areas 7A and 7B. In this case, it becomes apparent from the sectional illustration that the secondary bonding 7 relieves and encloses the primary bonding 5. This means that the secondary bonding 7 serves as a protection of the primary bonding 5. Therefore, the secondary bonding 7, besides redundancy, fulfils the additional function of protecting the primary bonding 5 from surrounding media (e.g. air and/or water). The primary bonding 5 is applicable by means of a bonding surface 6 and the areas of the secondary bonding 7A, 7B are applicable by means of bonding surfaces 8, 8′ to the structural component 3. On the opposite side, the primary bonding 5 is applicable to a bonding surface 18 and the secondary bonding 7A, 7B to bonding surfaces 16, 17 of a base structure 2. The primary bonding 5 adjoins the areas of the secondary bonding 7A, 7B and thus achieves the advantage of an enclosure. In this case, the surface 18, as can be seen in FIG. 1, is disposed at a projecting shoulder 19 of the base structure 2.

According to FIG. 2, a second embodiment of the adhesive system 1 is illustrated with a structural component 3 to be mounted at a base structure 2 (e.g. a wall). The illustration shows that the primary bonding 5, which has an adhesive with a high elastic modulus and great strength, is applied to a first bonding location 6 onto the structural component 3 to be mounted, which particularly has the shape of a glass panel. The inventive secondary bonding 7, which is applicable to a second bonding location 8 onto the structural component 3, has an elastically stretchable adhesive (e.g. silicone).

Furthermore, the adhesive system 1 has a mounting profile 4, which can be fixed at the base structure 2 and fastened at the structural component 3.

Furthermore, FIG. 2 shows that a carriage 9 can be placed between the mounting profile 4 and the structural component 3 and that an application adapter 10 is disposed between the carriage 9 and the structural component 3. The adapter 10 has a first mating surface 11 for the primary bonding 5 such that it can be bonded, e.g. to the glass panel (structural component 3), while considering bonding requirements.

Moreover, the adhesive system 1 has the secondary bonding 7, which cooperates with a second mating surface 12 located at the carriage 9. The carriage 9 has a roller assembly 15 and a base body 13, at which a reception 14 and an application adapter 10 are disposed. Through the connection of the application reception 14, the adapter 10 allows for adjustment in all directions in space. As the adapter 10 is designed such that its thickness is as small as possible, the glass can still be well stacked for transporting purposes. Thus glass machining is eliminated and the load carrying capacity is maintained.

FIG. 2 reveals in addition that the base body 13 has a mating surface 12 for the secondary bonding 7.

### List of Reference Numerals

1 adhesive system
2 base structure
3 structural component
4 mounting profile
5 primary bonding
6 first bonding location
7 secondary bonding
7A, 7B bonding area
8,8′ second bonding location
9 carriage
10 application adapter
11 first mating surface
12 second mating surface
13 base body
14 application reception
15 roller assembly
16, 17, 18 bonding surfaces
19 shoulder

1-8. (canceled)

9. An adhesive system comprising:
a structural component to be mounted to a base structure, the structural component having a first bonding location and a second bonding location;
a primary bonding applied to the first bonding location of the structural component to bond the structural component to the base structure, the primary bonding comprising an adhesive of a strength sufficient to securely bond the structural component to the base structure; and
a secondary bonding applied to the second bonding location of the structural component to bond the structural component to the base structure, the secondary bonding comprising an elastically stretchable adhesive.

10. The adhesive system of claim 9, further comprising a mounting profile connected to the structural component and the base structure.

11. The adhesive system of claim 10, further comprising a carriage positioned between the mounting profile and the structural component, the carriage connecting the structural component to the mounting profile.

12. The adhesive system of claim 11, further comprising an application adapter positioned between the carriage and the structural component, the application adapter being supported by the carriage and having a first mating surface for the primary bonding.

13. The adhesive system of claim 12, wherein the carriage has a second mating surface for the secondary bonding.

14. The adhesive system of claim 11, wherein the carriage comprises a roller assembly and a base body, the adhesive system further comprising a reception attached to the base body, and an application adapter attached to the reception and having a first mating surface for the primary bonding.

15. The adhesive system of claim 14, wherein the base body has a second mating surface for the secondary bonding.

16. The adhesive system of claim 9, wherein the secondary bonding has two bonding areas which enclose the primary bonding.

17. The adhesive system of claim 9, wherein the structural component comprises a glass panel.
